(19) United States
(12) Patent Application Publication
(10) Pub. No.: US 2010/0109838 A1
(43) Pub. Date: May 6, 2010

(54) Fingerprint unlocking system

(76) Inventor: Sherard Fisher, Bridgeville, DE (US)

Correspondence Address: RUTH EURE, 4795 EDISON AVENUE, BOULDER, CO, 80301, US

(21) Appl. No.: 12/584,642

(22) Filed: Sep. 8, 2009

Related U.S. Application Data
(60) Provisional application No. 61/191,408, filed on Sep. 8, 2008.

(51) Int. Cl. G05B 19/00

(52) U.S. Cl. 340/5.72; 340/5.83

(57) ABSTRACT

An apparatus, and a corresponding method for its use, for gaining access to a vehicle, such as a car by means of at least one fingerprint sensor installed at a convenient location outside the vehicle in or near a door handle. The illustrative embodiment of the invention includes a fingerprint sensor mounted in a convenient exterior location on the vehicle. The fingerprint matching controller includes means for unlocking at least one vehicle passenger access door upon verification of the identity of a user placing a finger in the fingerprint sensor. Preferably, the fingerprint sensor is located near, or integrated into a door handle, for ease of operation while opening a door of the vehicle.

### CLAIM OF PRIORITY

The present application claims priority from U.S. Provisional Patent Application 61/191,408, filed Sep. 8, 2008, of common inventorship and title herewith.

### FIELD OF THE INVENTION

The present invention pertains to the field of vehicle security, and more specifically to the field of biometric vehicle security.

### BACKGROUND OF THE INVENTION

The prior art has put forward several devices and methods for biometric security and controlling access to vehicles. Among these are:

U.S. Pat. No. 6,614,920 to Floyd is directed to a fingerprint operated ignition switch and entry system for a vehicle.

U.S. Pat. No. 6,100,811 to Hsu et al is directed to fingerprint actuation of customized vehicle features.

U.S. Pat. No. 6,727,800 to Dutu is directed to a keyless system for entry and operation of a vehicle.

None of these prior art references describe the invention of the present application.

### SUMMARY OF THE INVENTION

With the continued sprawl of urbanization and the increasing preference of the automobile as a cost-effective mode of travel, people are spending more and more time behind the wheel. The average commuter spends about 1.33 hours a day in a vehicle, which is the equivalent to almost 14 full days per year. Factoring in driving children to school and recreation activities, necessary trips to the market for supplies, and spur-of-the moment weekend road adventures, these numbers would surely expand. While automobiles are essential to day-to-day life, driving can often bring about its own unique brands of stress, particularly in today's hectic and fast-paced world. With so many distractions occupying the minds of busy people, it is little wonder that they may not notice that they are about to run out of gas, before it is too late, or they inadvertently lock their keys in the car when rushing out of it to their destination. The latter is perhaps one of the most common, not to mention embarrassing, experiences of the modern driver. That unpleasant, sinking feeling in the pit of the stomach when realizing that all access to the car is locked securely away from them is bad enough, but when they are informed by a locksmith how much it is going to cost to unlock the car surely makes these harried motorists even more nauseous.

The present invention is the Fingerprint Unlocking System, a practical invention that offers a convenient solution to the aforementioned problem. As the name implies, the Fingerprint Unlocking System is envisioned as just that, a fingerprint identification system, specially designed for motor vehicles that allows keyless access to a locked car upon proper recognition.

As conceived, the Fingerprint Unlocking System is a specially designed, pad type device, placed on the car's door handle that scans the owner's fingerprint, match it with its internal memory, and then automatically unlock the vehicle. This invention can be made available as an aftermarket device, easily installed on any vehicle, or incorporated into the design of automobiles at point of manufacture.

It is an object of the present invention to provide a fingerprint identification system, specially designed for motor vehicles, that allows keyless access to a locked car upon proper fingerprint recognition.

To present a better understanding of how the present invention works, the following text will deal with electronic fingerprint recognition.

### BRIEF DESCRIPTION OF THE DRAWINGS

FIG. 1 shows a vehicle door handle incorporating the fingerprint recognition pad of the present invention.

FIG. 2 shows a driver utilizing the fingerprint recognition pad of the present invention on a vehicle door handle.

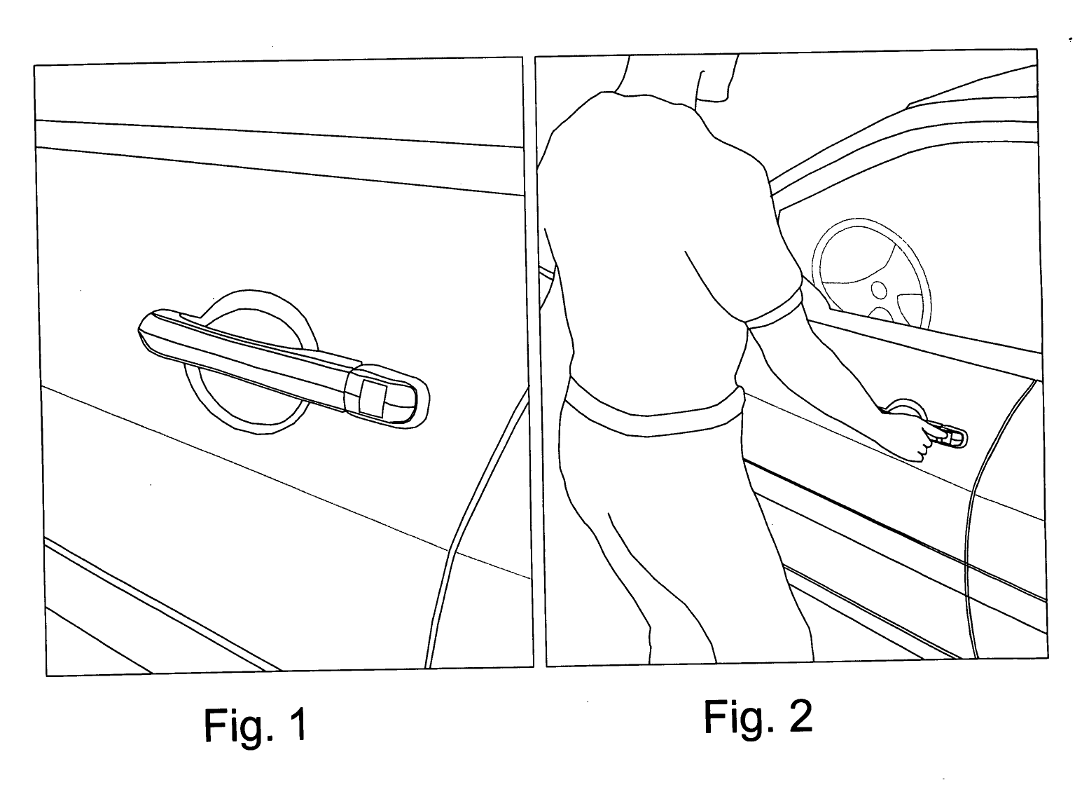

### DETAILED DESCRIPTION OF THE INVENTION

The present invention provides a fingerprint unlocking system for controlling access to a vehicle using fingerprint matching, the apparatus comprising a fingerprint sensor mounted in a convenient interior location in a vehicle, for generating a two-dimensional fingerprint image of a user of the vehicle; and a high-speed fingerprint matcher, for searching the entire two-dimensional sensed fingerprint image for instances of distinctive features similar to each of a plurality of pattern features that have been extracted from a previously stored reference fingerprint image, to verify the identity of the user of the vehicle; and a fingerprint match controller, for selecting from a plurality of stored reference fingerprint images for presentation to the fingerprint matcher, and having a locked mode of operation and an unlocked mode of operation; and means included in the fingerprint match controller, for switching from the locked mode to the unlocked mode upon successfully verifying the identity of a vehicle user; and means operable in the unlocked mode, for actuating the engine enabling switch to allow operation of the vehicle; and storage means for recording actuator settings associated with user identities; and means operable in the unlocked mode, for operating the actuator based on settings retrieved from the storage means for an identified user. The present invention resides in apparatus, and a method for its use, for automatically verifying the identity of a person seeking entry to and use of a protected vehicle. Briefly, and in general terms, the apparatus of the present invention comprises a fingerprint sensor mounted in a convenient location on a vehicle; a high-speed fingerprint matcher, for comparing a sensed fingerprint image with features of a previously stored reference fingerprint image, to verify the identity of a user of the vehicle; a fingerprint match controller, for selecting from a plurality of stored reference fingerprint images for presentation to the fingerprint matcher, and having a locked mode or operation and an unlocked mode of operation.

A fingerprint scanner system has two basic jobs: it needs to get an image of your finger, and it needs to determine whether the pattern of ridges and valleys in this image matches the pattern of ridges and valleys in pre-scanned images. There are a number of different ways to get an image of somebody's finger. The most common methods today are optical scanning and capacitance scanning. Both types come up with the same sort of image, but they go about it in completely different ways.

The heart of an optical scanner is a charge coupled device (CCD), the same light sensor system used in digital cameras and camcorders. A CCD is simply an array of light-sensitive diodes called photosites, which generate an electrical signal in response to light photons. Each photosite records a pixel, a tiny dot representing the light that hit that spot. Collectively, the light and dark pixels form an image of the scanned scene (a finger, for example). Typically, an analog-to-digital converter in the scanner system processes the analog electrical signal to generate a digital representation of this image. The scanning process starts when you place your finger on a glass plate, and a CCD camera takes a picture. The scanner has its own light source, typically an array of light-emitting diodes, to illuminate the ridges of the finger. The CCD system actually generates an inverted image of the finger, with darker areas representing more reflected light (the ridges of the finger) and lighter areas representing less reflected light (the valleys between the ridges). Before comparing the print to stored data, the scanner processor makes sure the CCD has captured a clear image. It checks the average pixel darkness, or the overall values in a small sample, and rejects the scan if the overall image is too dark or too light. If the image is rejected, the scanner adjusts the exposure time to let in more or less light, and then tries the scan again. If the darkness level is adequate, the scanner system goes on to check the image definition (how sharp the fingerprint scan is). The processor looks at several straight lines moving horizontally and vertically across the image. If the fingerprint image has good definition, a line running perpendicular to the ridges will be made up of alternating sections of very dark pixels and very light pixels. If the processor finds that the image is crisp and properly exposed, it proceeds to comparing the captured fingerprint with fingerprints on file.

Like optical scanners, capacitive fingerprint scanners generate an image of the ridges and valleys that make up a fingerprint. But instead of sensing the print using light, the capacitors use electrical current. A simple capacitive sensor is made up of one or more semiconductor chips containing an array of tiny cells. Each cell includes two conductor plates, covered with an insulating layer. The cells are tiny, typically smaller than the width of one ridge on a finger. The sensor is connected to an integrator, an electrical circuit built around an inverting operational amplifier. The inverting amplifier is a complex semiconductor device, made up of a number of transistors, resistors and capacitors. Like any amplifier, an inverting amplifier alters one current based on fluctuations in another current. Specifically, the inverting amplifier alters a supply voltage. The alteration is based on the relative voltage of two inputs, called the inverting terminal and the non-inverting terminal. In this case, the non-inverting terminal is connected to ground, and the inverting terminal is connected to a reference voltage supply and a feedback loop. The feedback loop, which is also connected to the amplifier output, includes the two conductor plates.

The two conductor plates form a basic capacitor, an electrical component that can store charge. The surface of the finger acts as a third capacitor plate, separated by the insulating layers in the cell structure and, in the case of the fingerprint valleys, a pocket of air. Varying the distance between the capacitor plates (by moving the finger closer or farther away from the conducting plates) changes the total capacitance (ability to store charge) of the capacitor. Because of this quality, the capacitor in a cell under a ridge will have a greater capacitance than the capacitor in a cell under a valley.

To scan the finger, the processor first closes the reset switch for each cell, which shorts each amplifier's input and output to “balance” the integrator circuit. When the switch is opened again, and the processor applies a fixed charge to the integrator circuit, the capacitors charge up. The capacitance of the feedback loop's capacitor affects the voltage at the amplifier's input, which affects the amplifier's output. Since the distance to the finger alters capacitance, a finger ridge will result in a different voltage output than a finger valley.

The scanner processor reads this voltage output and determines whether it is characteristic of a ridge or a valley. By reading every cell in the sensor array, the processor can put together an overall picture of the fingerprint, similar to the image captured by an optical scanner. The main advantage of a capacitive scanner is that it requires a real fingerprint-type shape, rather than the pattern of light and dark that makes up the visual impression of a fingerprint. This makes the system harder to trick. Additionally, since they use a semiconductor chip rather than a CCD unit, capacitive scanners tend to be more compact that optical devices.

With the above referenced technology incorporated to offer a means of unlocking a vehicle simply by fingerprint recognition, an invention such as the Fingerprinting Unlocking System offers many benefits and advantages to motorists. In the event they lock the keys in the car, they need only place a finger on the door handle, and the system would automatically disengage the locks on the door. Not only does this quick process allow the motorist to retrieve his keys in a matter of seconds, he can also avoid the embarrassment of others seeing that he just committed the self-perceived, bone-headed move of locking his keys in the car. Moreover, this device handily eliminates the need to call an expensive locksmith, saving the motorist as much as $100.00, if not more. Fully developed and affordably priced, a device such as the Fingerprint Unlocking System will be well received by vehicle owners the world over, an extremely sizable market potential.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A fingerprint unlocking system for controlling access to a vehicle using fingerprint matching, the apparatus comprising:
a fingerprint sensor mounted in a convenient interior location in a vehicle, for generating a two-dimensional fingerprint image of a user of the vehicle;
a high-speed fingerprint matcher, for searching the entire two-dimensional sensed fingerprint image for instances of distinctive features similar to each of a plurality of pattern features that have been extracted from a previously stored reference fingerprint image, to verify the identity of the user of the vehicle;
a fingerprint match controller, for selecting from a plurality of stored reference fingerprint images for presentation to the fingerprint matcher, and having a locked mode of operation and an unlocked mode of operation;
means included in the fingerprint match controller, for switching from the locked mode to the unlocked mode upon successfully verifying the identity of a vehicle user;
means operable in the unlocked mode, for actuating the engine enabling switch to allow operation of the vehicle;
storage means for recording actuator settings associated with user identities; and
means operable in the unlocked mode, for operating the actuator based on settings retrieved from the storage means for an identified user.

2. Apparatus as defined in claim 1, wherein the at least one actuator is selected from the group comprising: a seat adjustment actuator, a mirror actuator, a steering wheel position actuator, a climate control actuator, a mobile telephone actuator, a vehicle performance control actuator, an entertainment device actuator, an airbag setting actuator, and an onboard computer actuator.

3. Apparatus as defined in claim 1, wherein the fingerprint sensor is integrated into a door handle, for operation while opening a door of the vehicle.

4. Apparatus as defined in claim 1, and further comprising:
a user interface for selection of modes of operation and user identities; and
means included in the fingerprint match controller, for switching to a new selected mode of operation upon verification of the identity of a user.
